(19) United States
(12) Patent Application Publication
(10) Pub. No.: US 2014/0317516 A1
(43) Pub. Date: Oct. 23, 2014

(54) ADDRESS FORMATTING ON A DIGITAL MAP

(71) Applicant: Google Inc., (US)

(72) Inventors: Alan Gordon Doubleday, Macquarie Park (AU); Jordan Bayliss-McCulloch, Waterloo (AU)

(73) Assignee: Google Inc., Mountain View, CA (US)

(21) Appl. No.: 13/867,546

(22) Filed: Apr. 22, 2013

(51) Int. Cl. G06F 3/0484

(52) U.S. Cl. CPC G06F 3/0484
USPC 715/738

(57) ABSTRACT

A computerized method or system may format addresses for locations within a digital map. The method or system may send a map data request for map data corresponding to a geographic area. The map data request may include a search query term corresponding to a location within the geographic area. The method or system may receive both the map data corresponding to the geographic area and address data corresponding to the location within the geographic area. The received map data may include data corresponding to a plurality of graphic elements and the received address data may include an ordered collection of address elements. The method or system may determine that more than one graphic element within the received map data represents an ordered address element of the received address data and display only the ordered address element and a next lowest address element of the received ordered collection.

### FIELD OF THE DISCLOSURE

The present disclosure relates to digital maps and, more particularly, to formatting and displaying postal addresses for map markers being displayed as part of digital maps on a computing device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, a wide variety of computing devices, including many portable devices, support software applications that display digital maps (“mapping applications”). For example, mapping applications may run on laptop and tablet computers, mobile phones, car navigation systems, hand-held global positioning system (GPS) units, etc.

In general, a mapping application can display various types of geographic data including topographical data, street data, urban transit information, and traffic data on a map. Further, the geographic data may be schematic or based on photography, such as satellite imagery. In addition, a user may submit search queries and, in response, be presented with map markers that are displayed on the map at locations responsive to the search queries. To indicate the physical location of a map marker, the mapping application may show a postal address for the map marker either on a sidebar next to the map, or in a pop-up informational window when the user hovers over or clicks on the map marker. However, in order to conveniently provide the user with more information, it may be useful to display the postal address directly on the map next to the map marker.

### SUMMARY

The features and advantages described in this summary and the following detailed description are not all-inclusive. Many additional features and advantages will be apparent to one of ordinary skill in the art in view of the drawings, specification, and claims hereof.

A mapping application may display parts of the postal address for a map marker on the map based on the map viewport. For a given zoom level, the mapping application may determine the precision of the postal address within the viewport and format the address so that only the most relevant parts of the postal address are displayed next to the map marker. For example, for a zoom level that shows several countries within the viewport, the mapping application may display parts of the postal address that correspond to the country and the administrative division (e.g., state, province, territory, etc.) within the country. As the zoom level changes, the mapping application may dynamically establish the viewport address precision and display the appropriate parts of the postal address. When a street level zoom is reached, the mapping application may display the most precise part of the postal address (i.e., street number and street name).

A computerized method may format addresses for locations within a digital map. The method may send a map data request from a client computing device to a mapping system for map data corresponding to a geographic area. The map data request may include a search query term corresponding to a location within the geographic area. The method may receive both the map data corresponding to the geographic area and address data corresponding to the location within the geographic area in response to the map data request. The received map data may include data corresponding to a plurality of graphic elements and the received address data may include an ordered collection of address elements. The method may then determine that more than one graphic element within the received map data represents an ordered address element of the received address data and display only the ordered address element and a next lowest address element of the received ordered collection of address elements with the received map data at the client computing device.

A computer-readable medium may store tangible computer executable instructions to format addresses for locations within a map. The map may be displayed in a viewport of a mapping application executing on a client computing device. The medium may comprise several instructions. For example, an instruction may send a map data request from a client computing device to a mapping system for map data corresponding to a geographic area. The map data request may include a search query term corresponding to a location within the geographic area. Another instruction may receive both the map data corresponding to the geographic area and address data corresponding to the location within the geographic area in response to the map data request. The received map data may include data corresponding to a plurality of graphic elements and the received address data may include an ordered collection of address elements. A further instruction may determine that more than one graphic element within the received map data represents an ordered address element of the received address data. A still further instruction may display only the ordered address element and a next lowest address element of the received ordered collection of address elements with the received map data at the client computing device.

A computer system may also format addresses for locations within a map that is displayed in a viewport of a mapping application executing on the computer system. The system may comprise a processor, a memory communicatively coupled to the processor, and a mapping module including instructions stored in the memory for execution by the processor. One instruction may send a map data request from the computer system to a mapping system for map data corresponding to a geographic area. The map data request may include a search query term corresponding to a location within the geographic area. Another instruction may receive both the map data corresponding to the geographic area and address data corresponding to the location within the geographic area in response to the map data request. The received map data may include data corresponding to a plurality of graphic elements and the received address data may include an ordered collection of address elements. A further instruction may determine that more than one graphic element within the received map data represents an ordered address element of the received address data. A still further instruction may display only the ordered address element and a next lowest address element of the received ordered collection of address elements with the received map data.

A computerized apparatus may format addresses for locations within a digital map. The apparatus may include means for sending a map data request from a client computing device to a mapping system for map data corresponding to a geographic area. The map data request may include a search query term corresponding to a location within the geographic area. The apparatus may also include means for receiving both the map data corresponding to the geographic area and address data corresponding to the location within the geographic area in response to the map data request. The received map data may include data corresponding to a plurality of graphic elements and the received address data may include an ordered collection of address elements. The apparatus may further include means for determining that more than one graphic element within the received map data represents an ordered address element of the received address data. The apparatus may still further include means for displaying only the ordered address element and a next lowest address element of the received ordered collection of address elements with the received map data at the client computing device.

### BRIEF DESCRIPTION OF THE DRAWINGS

FIG. 1 is a block diagram of a system for formatting and displaying a postal address for a map marker on a map being displayed on a computing device;

FIG. 2 is a flow diagram of an example method for formatting and displaying portions of a postal address for a map marker on a map;

FIG. 3A is an example screenshot which a mapping application can generate to display portions of a postal address for a map marker on a map based on a low zoom level and a map viewport;

FIG. 3B is an example screenshot which a mapping application can generate to display portions of a postal address for a map marker on a map based on a low zoom level and a map viewport;

FIG. 3C is an example screenshot which a mapping application can generate to display portions of a postal address for a map marker on a map based on a medium zoom level and a map viewport;

FIG. 3D is an example screenshot which a mapping application can generate to display portions of a postal address for a map marker on a map based on a high zoom level and a map viewport; and

FIG. 4 is a block diagram of computing environment that implements a system and method for formatting and displaying portions of a postal address for a map marker on a map.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

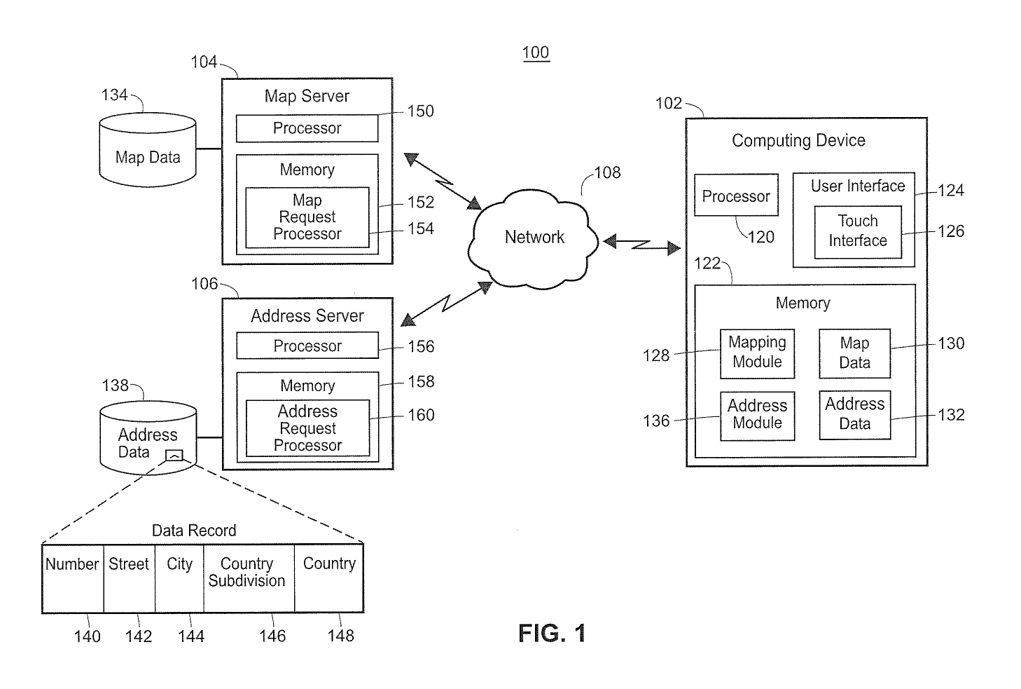

Referring first to FIG. 1, a system 100 includes a computing device 102 coupled to a mapping system 103 including a map server 104 and an address server 106 via a communication network 108. The computing device 102 can be, for example, a smartphone, a tablet computer, a laptop computer, a navigation device mounted in a vehicle, etc. The network 108 in general can include wired and/or wireless communication links and may include, for example, a wide area network (WAN) such as the Internet, a local area network (LAN), a cellular telephone network, or any other suitable types of network.

In the embodiment shown in FIG. 1, the computing device 102 includes a processor 120, a computer-readable memory 122, and a user interface 124 including a touch interface 126. In various implementations, the touch interface 126 can include a touchpad over which the user moves his fingers while looking at a separately provided screen, a touchscreen where the user places his fingers directly over the image being manipulated or over a displayed control being activated (e.g. a displayed keyboard), etc. The processor 120 may include a central processing unit (CPU), for example. More generally, the portable computing device 102 can include one or more processors and, if desired, one or more graphics processing units (CPUs) as well as other processing units. The memory 122 is a computer-readable non-transitory storage device that may include both persistent (e.g., a hard disk, a flash drive) and non-persistent (e.g., RAM) memory components. The memory 122 stores instructions that are executable on the processor 120 and that make up the instructions of a mapping software module 128. The memory 122 also stores map data 130 and address data 132 that is used by instructions of the mapping module 128. In various implementations, the computing device 102 can include additional components, such as one or more wired and/or wireless network interfaces, peripheral devices such as a mouse, etc.

In operation, the mapping module 128 may generate requests for map data in accordance with how the user positions a map viewport using pan, zoom, and other controls. The map viewport may be a portion of a graphical user interface of the mapping module 128 that displays a graphical representation of map data received at the client computing device in response to a request for the map data. A request for map data can specify, for example, the geographic area for which the computing device 102 will display a digital map, the zoom level, and the desired layers of additional information (e.g., traffic, weather, satellite imagery, etc.) within the map viewport. The computing device 102 may transmit the requests to the map server 104. In response, the map server 104 may retrieve map data from a map database 134 and provide the map data to the computing device 102 via the network 108 (in the form of one or more messages). The computing device 102 may then store the received map data in the memory 122 as the map data 130.

The mapping software module 128 according to various implementations may operate as a separately executable software application, a plugin that extends the functionality of another software application such as a web browser, an application programming interface (API) that may be invoked by a software application, etc. The instructions that make up the mapping module 128 may be compiled and executable on the processor 120 directly, or interpreted by the processor 120 at runtime.

Depending on the implementation, the map data 130 may be in a raster format, such as Portable Network Graphics (PNG), a vector graphics format (based on mathematical descriptions of geometric shapes), or any other suitable format. The map data 130 in some cases is divided into map tiles, or portions of a digital map having a certain fixed size, such as 256 by 256 pixels. The mapping software module 128 may render or assemble a digital map based on the map data and cause the digital map to be displayed via the user interface 124 within a viewport. When the computing device 102 receives the map data 130 rasterized, the mapping module 128 may generate the digital map by selecting and combining the proper rasterized tiles. If the computing device 102 receives the map data 130 in a vector graphics format, the mapping module 128 may first interpret the descriptions of various shapes and then apply specified textures to the shapes to generate the corresponding raster images. The mapping software module 128 may also adjust the displayed digital map and request new map data, when necessary, in response to user input received via the user interface 124. More specifically, the user may change the zoom level, pan across the map, and otherwise interact with the map as it is displayed within the viewport on the user interface 124.

When interacting with the map, the user may enter search queries to find points of interest or point locations that the user may find useful or interesting in the viewport or geographic area displayed in the map on the user interface 124. For example, the user may submit search queries to locate restaurants, hotels, landmarks, etc. In response to submitting the search queries, the mapping module 128 may display map markers on the map which represent the search results. For example, map markers may appear on the map to represent the locations of individual restaurants. For each displayed map marker, the mapping module 128 may also display a postal address corresponding to the physical location of the marker. To do so, the mapping software module 128 may cause the processor 120 to execute one or more instructions of an address module 136 to send a request to acquire postal address information for each map marker. In other embodiments, address data 132 may be sent to the computing device 102 along with the map data 130 in response to a request for map data.

In some implementations, when acquiring the postal address for each map marker in response to a request for map data, the address module 136 may communicate with the address server 106 via the network 108 to retrieve address data for the map marker from an address database 138. The address server 106 may then provide the retrieved address data to the computing device 102 to be stored in the memory 122 as the address data 132. Subsequently, the mapping module 128 may process the address data 132 to display the postal address information for a map marker on the map within the viewport via the user interface 124. In other implementations, the mapping software module 128 may first communicate with the map server 104 to retrieve map data, which may be embedded with map markers from the map database 134, and the map server 104 may in turn communicate with the address server 106 to retrieve address data for the map markers in the map data from the address database 138. The map server 104 may then provide the retrieved map data and address data to the computing device 102 to be stored and processed as the map data 130 and the address data 132, respectively.

The map data 130 may specify individual map elements representing such physical entities as buildings, roads, bodies of water, and other natural and artificial objects that are visible outside buildings (e.g., from above or at a street level) or inside buildings. The map data 130 can also include text-based label data (e.g., labels for displaying street names, names of landmarks, etc.) as well as metadata that include additional information about the physical entity. In a raster format, map elements typically are embedded into the same image of a digital map. In general, map data may be used to generate two-dimensional (2D) images or three-dimensional (3D) images, and may include schematic data used to create or render an image, photographic images, or both.

The address data 132 may specify information describing the location of a physical entity indicated by a map marker (e.g., a building, a landmark, a plot of land, etc.) using various address identifiers as references. Address identifiers may include house numbers, street names, country names, etc. Each record of the address data 132 may be organized into any format or ordered precision. For example, each set of address data corresponding to a geographic location may begin with the smallest unit and end with the largest unit, or vice-versa, where each smaller unit is a member of each larger unit (e.g., each street address is a sub-unit of a street, each street is a sub-unit of a city, each city is a sub-unit of a county, each county is a sub-unit of a state, each state is a sub-unit of a country, etc.). For example, the address may begin with the house number and end with the country name corresponding to the physical entity, or start with the country name and end with the house number. As such, the address data 132 may conform to any worldwide postal address system. In the implementation illustrated in FIG. 1, the address data is in the form of a data record that includes a number field 140, a street field 142, a city field 144, a country subdivision field 146 and a country field 148.

As one example, the number field 140 of a certain data record may specify a unique number assigned to a particular structure such as a house or building in a street. The street field 142 may specify the name of the street. The city field 144 may specify the name of the city in which the street is located. The country subdivision field 146 may specify the name of the country subdivision (e.g., state, province, territory, etc.) to which the city belongs. The country field 148 may specify the name of the country containing the country subdivision.

In other implementations, the data records of the address data 136 can include fewer fields, or conversely, may include additional fields. For example, a data record in the address data 136 may include additional fields indicating other address identifiers such as floor levels in a building, districts within a city, postal codes, etc. Further, some of the data records may not have information in each of the fields 140-148. For example, for some address data records, country subdivisions may not exist and in such cases, a data record in the address data 136 may only specify the name of the city in the city field 144.

The mapping software module 128 may show the postal address information for a map marker displayed in a map according to the number of graphic elements visible at a user-selected zoom level within a map viewport. The graphic elements may include graphic representations of defined geographic areas that are typically illustrated on a map. For example, the graphic elements may represent a country, a country subdivision within the country (e.g., a state, province, territory, etc.), a city within the country subdivision, a street within the city, and a building having a number (e.g., a house or building number) within the street. The mapping module 128 may cause the processor to execute one or more instructions to determine the precision of the address within the map viewport and format the address so that only the most precise or relevant portions of the address are displayed with the map. In some embodiments, the relevant address elements are displayed next to the map marker. For example, when a user views a map in which several countries are visible within the map viewport, the mapping module 128 may cause the processor to display portions of the postal address that correspond to the country as well as the next-ordered precision part of the address (e.g., a country subdivision) for a map marker returned by a query to the mapping system. In some implementations, only the country may be displayed. To display the relevant portions of the address, the mapping module 128 may cause the processor to execute the address module 136 to retrieve all the address information fields for the map marker (e.g., the fields 140-148) and then select the appropriate fields to display (e.g., the country subdivision field 146 and the country field 148). Alternatively, the mapping module 128 may cause the processor to execute the address module 136 to retrieve only the relevant fields (e.g., the fields 146 and 148) to display. As the zoom level is modified within the viewport, the mapping module 128 may cause the processor to dynamically establish the precision of the postal address in the map viewport and display appropriate portions of the address. When the user reaches a high zoom level (e.g., a street level zoom), the mapping module 128 may cause the processor to display the most precise parts of the address (e.g., a house number and street name). By dynamically formatting and displaying the most relevant portions of the address as the user zooms in and out to view the map marker, the mapping module 128 may cause the processor to present address information in a manner that is both convenient and compact. Additionally, the user can view the full postal address at any given zoom level. For example, when a pointer of a pointing device hovers over or selects on the map marker, the processor may cause the address information to be displayed in a pop-up informational window.

In some implementations, when viewing multiple map markers in a geographic area, the mapping module 128 may cause the processor to execute an instruction to omit one or more portions of an address corresponding to the map marker and display the shortened address in visual proximity to the map marker. For example, various map markers may be displayed on a map to indicate different restaurants in a certain city. The relevant portions of the address may also be displayed for each restaurant map marker to include the street name and city name where each restaurant is located. However, in order to free up more screen space and remove unnecessary clutter, the mapping module 128 may not display the city name next to each map marker as all the restaurants are known to be located within the same city.

With continued reference to FIG. 1, the map server 104 may include a processor 150 and a memory 152 that stores a map request module 154 that includes instructions that are executable on the processor 150. Similarly, the address server 106 may include a processor 156 and a memory 158 that stores an address request module 160 including instructions that are executable on the processor 156.

For simplicity, FIG. 1 illustrates both the map server 104 and the address server 106 as single server devices. However, according to some implementations, the map server 104 and/or the address server 106 may include a group of one or more server devices, each equipped with one or more processors and capable of operating independently of the other server devices. For example, map server devices operating in such a group may process requests from the computing device 102 individually (e.g., based on availability), in a distributed manner where one operation associated with processing a request is performed on one map server device while another operation associated with processing the same request is performed on another map server device, or according to any other suitable technique. Further, the map server 104 and the address server 106 may be owned by a single business entity and located in a single geographic location (e.g., a server farm). Alternatively, the map server 104 and/or the address server 106 may be owned by different business entities and located across a number of geographic locations. For the purposes of this discussion, the term “map server” may refer to an individual map server device or to a group of two or more map server devices. Similarly, the term “address server” may refer to an individual address server device or to a group of two or more address server devices.

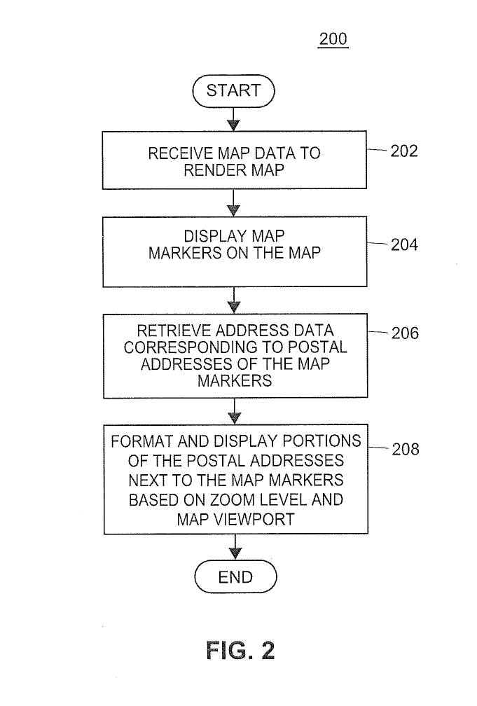

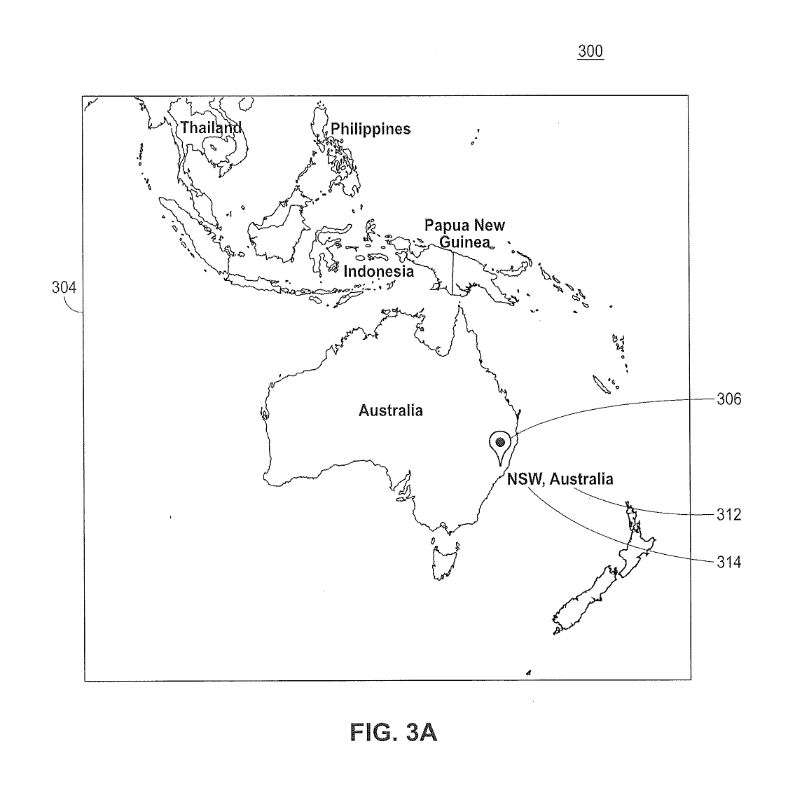

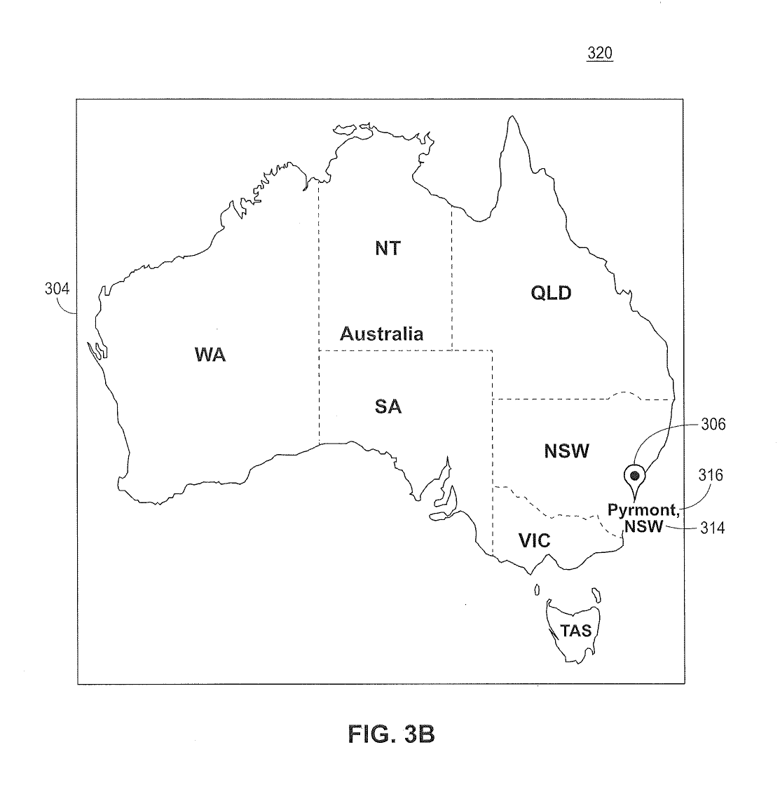

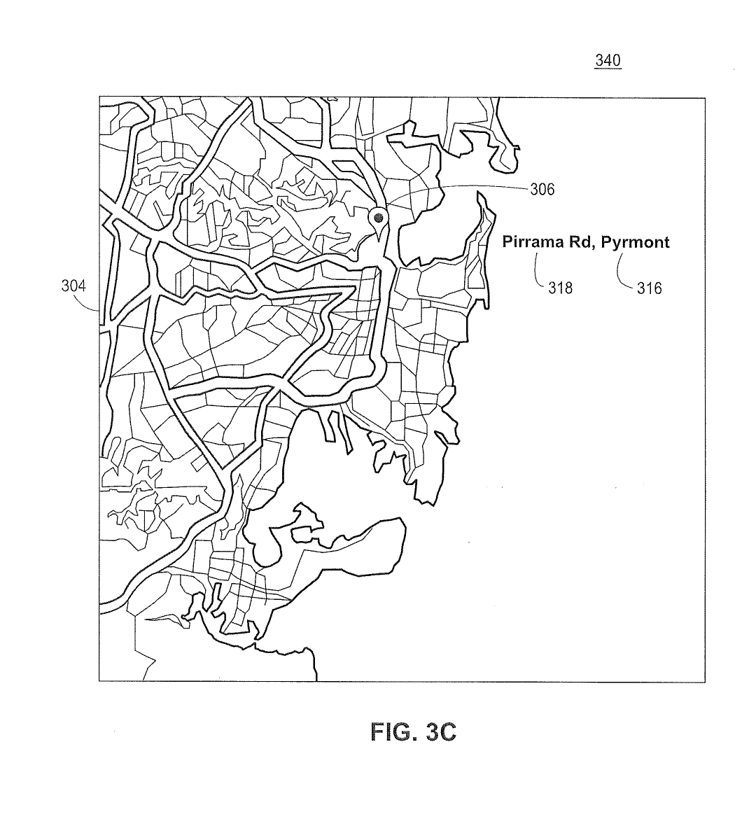

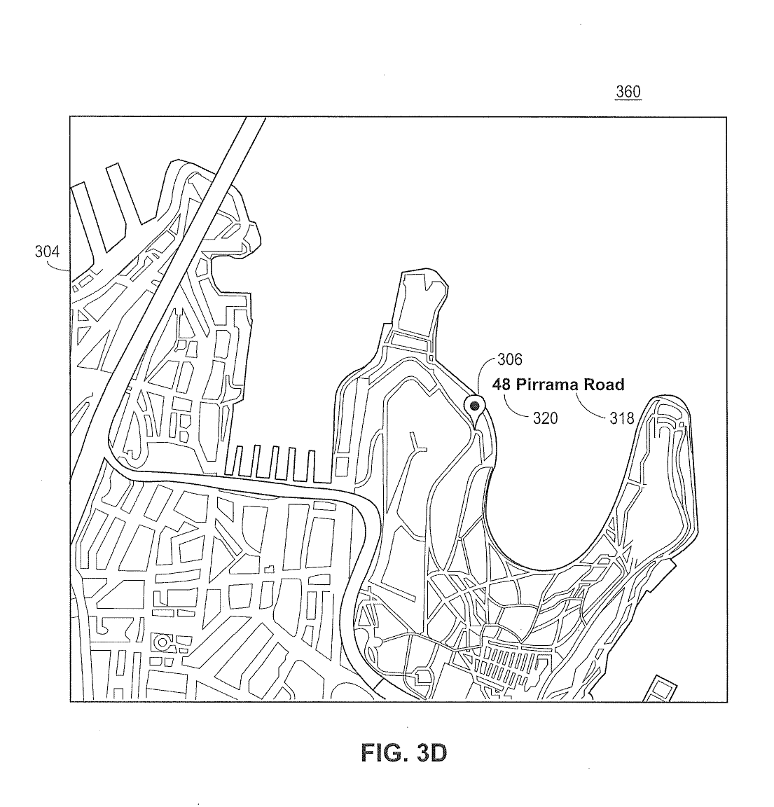

To further illustrate the techniques for formatting and displaying a postal address for a map marker on a digital map, a processor of a computing device may execute instructions of a mapping software module to implement a method 200 (FIG. 2) and generate screenshots 300, 320, 340 and 360 (FIGS. 3A-3D). In an example implementation, the method of FIG. 2 is implemented in the mapping software module 128 executed by the processor 120 of the computing device 102. More generally, however, the method may be implemented in any suitable software application or module, and may be implemented as one or more instructions stored on a computer-readable medium and executable on one or more processors.

The flow diagram of FIG. 2 illustrates an example method 200 for formatting and displaying portions of a postal address for a map marker on a map. At block 202, the processor 120 may execute an instruction to render a digital map for a specified geographic area on a display of the computing device 102. For example, the client computing device 102 may receive map data for the specified geographic area in response to sending a request to the map server 104 for map data 134. The specified geographic area may include an area that is generally bounded by a viewport of an instance of the mapping application executing on the client computing device. The viewport may be part of an interface of the mapping module 128 displaying a map within the user interface 124 on the computing device 102. By way of example only, the screenshot 300 in FIG. 3A illustrates a digital map of a geographic area that is generated when the processor 120 executes the instruction at block 202. The screenshot 300 is displayed in a map viewport 304.

At block 204, the processor 120 may execute an instruction to use the received map data to render map markers on the digital map in response to a user defined search query. For example, a user may submit a search query including one or more search query terms indicating a request for a point of interest in the specified geographic area. The point of interest may correspond to a particular geographic location within the specified geographic area. The map data 130 received by the client computing device 102 in response to the search query may include map marker data corresponding to a map marker for the particular geographic location. The processor 120 may then use the received map data including the map marker to render the map marker at the particular geographic location. Thus, the map marker indicates the location of the point of interest within the geographic area displayed within the viewport.

In some embodiments, in addition to the map marker data, the map data 130 received by the client computing device 102 in response to the search query may include address data corresponding to each location sent in response to the search query. The processor 120 may then use the received map data including the map marker and address data to render the map marker and address data corresponding to the map marker at the particular geographic location of the map marker. With continued reference to the screenshot 300 in FIG. 3A, a map marker 306 and address data 312, 314 may be displayed when the processor executes the instruction at the block 204. The map marker 306 and address data 312, 314 may be a result of a user search query to locate a physical structure such as a house or a building, for example.

In other embodiments, at block 206, the processor 120 may execute an instruction to retrieve address data for the map marker in order to indicate the physical location of the map marker on the map. For example, the computing device 102 may send a request to the address server 106 to retrieve address data 136. The retrieved address data may be an ordered collection of postal address information elements that include, for example, a country, a country subdivision within the country (e.g., a state, province, territory, etc.), a city within the country subdivision, a street within the city and a house number within the street. In some embodiments, the address data may be received as part or along with the map data. In this scenario, the computing device 102 may send a request to the map server 104 to retrieve map data 134, which may be embedded with map markers, and the map server 104 may in turn communicate with the address server 106 to retrieve address data 136 for the map markers. The map server 104 may then provide the retrieved map data 134 and address data 136 to the computing device 102.

Finally, at block 208, the processor 120 may execute an instruction to process the address data so that only precise portions of the postal address information are displayed next to the map marker on the map according to a number of graphic elements displayed within the viewport that represent an ordered element of the received address data. In some embodiments, the displayed portions of the postal address may include two or fewer pieces of information. For example, if two or more countries are visible in the map viewport, then the determined portions of the postal address to be displayed at the computing device 102 may include the country and the country subdivision within the country. Referring again to the screenshot 300 in FIG. 3A, to indicate the physical location of the map marker 306, the processor 120 executes the instruction at the block 208 to determine and display a portion of a postal address for the map marker 306 next to the map marker 306 based on the number of graphical elements that represent an ordered element of the received address data within the map viewport 304. As an example, the complete postal address for the map marker 306 may include a country 312, a country subdivision 314 (e.g., a state, territory, etc.), a city 316, a street 318 and a house number 320. In the screenshot 300 of FIG. 3A, the map marker 306 is viewed at a low zoom level where more than one country is displayed in the map viewport 304. As the number of countries visible is more than one, the displayed portions of the postal address for the map marker 306 in FIG. 3A include the country 312 and the country subdivision 314.

If only a single country is visible in the map viewport, then the determined portions of the postal address to be displayed with the map marker at the computing device 102 may include the country subdivision within the single country and the city within the country subdivision. With reference to FIG. 3B, the screenshot 320 shows the map marker 306 being viewed at a low zoom level that includes only one country in the map viewport 304 (e.g., “Australia”). Therefore, to determine the relevant portions of the postal address to display for the map marker 306, the processor 120 executes the instruction at the block 208 to determine the number of country subdivisions visible in the map viewport 304, which is more than one for FIG. 3B. Thus, the displayed portions of the postal address for the map marker 306 in FIG. 3B include the country subdivision 314 and the city 316.

If a single country subdivision is visible in the map viewport, then the determined portions of the postal address to be displayed with the map marker at the computing device 102 may include the city within the single country subdivision and the street within the city. With reference to FIG. 3C, the screenshot 340 shows the map marker 306 being viewed with only one country subdivision visible in the map viewport 304. Therefore, to determine the relevant portions of the postal address to display for the map marker 306, the processor 120 executes the instruction at the block 208 to determine the number of cities or towns visible in the map viewport 304. For FIG. 3C, the number of cities or towns visible is more than one. Thus, the displayed portions of the postal address for the map marker 306 in FIG. 3C include the city 316 as well as the street 318.

If individual streets are visible in the map viewport, then the determined portions of the postal address to be displayed with the map marker at the computing device 102 may include the street within the city and the house number within the street. With reference to FIG. 3D, the screenshot 360 shows the map marker 306 being viewed at a high zoom level in which individual streets are visible in the map viewport 304. Thus, the processor 120 executes the instruction at the block 208 to determine and display the most precise portions of the postal address for the map marker 306, which are represented by the street 318 and the house number 320.

Using the system 100 and method 200 described herein, postal address information for a map marker on a digital map may be formatted and displayed next to the map marker to convey the information in a convenient and compact manner.

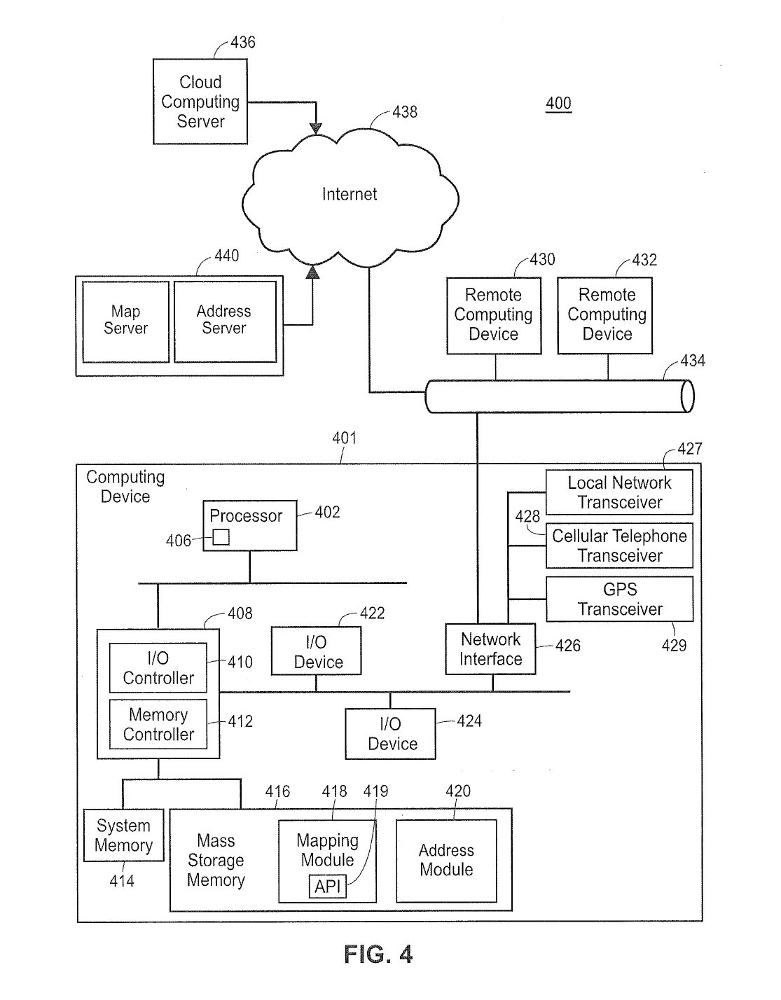

FIG. 4 is a high-level block diagram of an example computing environment for a mobile mapping system 400 having a computing device 401 that may be used to implement the method and systems described herein. The computing device 401 may include the computing device 102 (e.g., a cellular phone, a tablet computer, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example mobile mapping system 400 may be used to implement and execute the example system of FIG. 1, the method of FIG. 2, the screenshots of FIGS. 3A-3D, and the like. Although the example mobile mapping system 400 is described below as including a plurality of peripherals, interfaces, chips, memories, etc., one or more of those elements may be omitted from other example processor systems used to implement and execute the example system 100 to display dynamic map content. Also, other components may be added.

As shown in FIG. 4, the computing device 401 includes a processor 402 that is coupled to an interconnection bus 404. The processor 402 includes a register set or register space 406, which is depicted in FIG. 4 as being entirely on-chip, but which could alternatively be located entirely or partially off-chip and directly coupled to the processor 402 via dedicated electrical connections and/or via the interconnection bus 404. The processor 402 may be any suitable processor, processing unit or microprocessor. Although not shown in FIG. 4, the computing device 401 may be a multi-processor device and, thus, may include one or more additional processors that are identical or similar to the processor 402 and that are communicatively coupled to the interconnection bus 404.

The processor 402 of FIG. 4 is coupled to a chipset 408, which includes a memory controller 410 and a peripheral input/output (I/O) controller 412. As is well known, a chipset typically provides I/O and memory management functions as well as a plurality of general purpose and/or special purpose registers, timers, etc. that are accessible or used by one or more processors coupled to the chipset 408. The memory controller 410 performs functions that enable the processor 402 (or processors if there are multiple processors) to access a system memory 414 and a mass storage memory 416, that may include either or both of an in-memory cache (e.g., a cache within the memory 414) or an on-disk cache (e.g., a cache within the mass storage memory 416).

The system memory 414 may include any desired type of volatile and/or non-volatile memory such as, for example, static random access memory (SRAM), dynamic random access memory (DRAM), flash memory, read-only memory (ROM), etc. The mass storage memory 416 may include any desired type of mass storage device. For example, if the computing device 401 is used to implement a mapping module 418 having an API 419 and an address module 420. The mass storage memory 416 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 401 and the mobile mapping system 400. Thus, a module, block, function, operation, procedure, routine, step, and method can be implemented in hardware, firmware, and/or software. In one embodiment, program modules and routines (e.g., the mapping module 418, the API 419, the address module 420, etc.) are stored in mass storage memory 416, loaded into system memory 414, and executed by a processor 402 or can be provided from computer program products that are stored in tangible computer-readable storage mediums (e.g., RAM, hard disk, optical/magnetic media, etc.).

The peripheral I/O controller 410 performs functions that enable the processor 402 to communicate with peripheral input/output (I/O) devices 422 and 424, a network interface 426, a cellular network transceiver 427, a local network transceiver 428, and a GPS transceiver 429 (via the network interface 426) via a peripheral I/O bus 428. The I/O devices 422 and 424 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O devices 422 and 424 may be used with the mapping module 418 and/or the address module 420 to receive GPS data from the GPS transceiver 429, send the GPS data to the backend components of the system 100, render, and display maps and user interfaces as described in relation to the figures. A cellular telephone transceiver 427 may be resident with the local network transceiver 428. The local network transceiver 428 may include support for a Wi-Fi network, Bluetooth, Infrared, or other wireless data transmission protocols. In other embodiments, one element may simultaneously support each of the various wireless protocols employed by the computing device 401. For example, a software-defined radio may be able to support multiple protocols via downloadable instructions. In operation, the computing device 401 may be able to periodically poll for visible wireless network transmitters (both cellular and local network) on a periodic basis. Such polling may be possible even while normal wireless traffic is being supported on the computing device 401. The network interface 428 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 412 and the I/O controller 410 are depicted in FIG. 4 as separate functional blocks within the chipset 408, the functions performed by these blocks may be integrated within a single integrated circuit or may be implemented using two or more separate integrated circuits. The mobile mapping system 400 may also implement the mapping module 418 and the address module 420 on remote computing devices 430 and 432. The remote computing devices 430 and 432 may communicate with the computing device 401 over an Ethernet link 434. For example, the computing device 401 may receive mapping data created by a mapping application executing on a remote computing device 430, 432. In some embodiments, the mapping module 418 and/or the address module 420 may be retrieved by the computing device 401 from a cloud computing server 436 via the Internet 438. When using the cloud computing server 436, the retrieved mapping module 418 and/or the address module 420 may be programmatically linked with the computing device 401. The mapping module 418 and/or the address module 420 may be a Java® applet executing within a Java® Virtual Machine (JVM) environment resident in the computing device 401 or the remote computing devices 430, 432. The mapping module 418 and/or the address module 420 may also be “plug-ins” adapted to execute in a web-browser located on the computing devices 401, 430, and 432. In some embodiments, the mapping module 418 and/or the address module 420 may communicate with back end components 440 such as the map server 104 and the address server 106 via the Internet 438.

The system 400 may include but is not limited to any combination of a LAN, a MAN, a WAN, a mobile, a wired or wireless network, a private network, or a virtual private network. Moreover, while only three remote computing devices 430 and 432 are illustrated in FIG. 4 to simplify and clarify the description, it is understood that any number of client computers are supported and can be in communication within the system 400.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” means that a particular element, feature, structure, or characteristic described in connection with the embodiment is included in at least one embodiment. The appearances of the phrase “in some embodiments” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments of a system for displaying dynamic map content based on the user's location and application data for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process that formats and displays postal address information for a map marker displayed on a mobile computing device through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for formatting addresses for locations within a map that is displayed in a viewport of a mapping application executing on a client computing device, the method comprising:
sending a map data request from a client computing device to a mapping system for map data corresponding to a geographic area, the map data request including a search query term corresponding to a location within the geographic area;
receiving both the map data corresponding to the geographic area and address data corresponding to the location within the geographic area in response to the map data request, the received map data including data corresponding to a plurality of graphic elements and the received address data including an ordered collection of address elements;
determining that more than one graphic element within the received map data represents an ordered address element of the received address data; and
displaying only the ordered address element and a next lowest address element of the received ordered collection of address elements with the received map data at the client computing device.

2. The method of claim 1, wherein the graphic element illustrates a country, a country subdivision within the country, a city within the country subdivision, a street within the city, or a building having a number within the street.

3. The method of claim 2, wherein the ordered collection of address elements includes, from highest to lowest, one or more of a country, a country subdivision within the country, a city within the country subdivision, a street within the city, and a house number within the street.

4. The method of claim 1, wherein determining that more than one graphic element within the received map data represents the ordered address element of the received address data includes determining that more than one graphic element within the received map data that is displayed within a viewport of the client computing device represents the ordered address element of the received address data.

5. The method of claim 4, wherein the viewport includes a portion of a graphical user interface for a mapping module executing on the client computing device and the viewport displays a graphical representation of the received map data.

6. The method of claim 5, wherein sending the map data request from the client computing device to the mapping system for map data corresponding to the geographic area includes sending the map data request from the client computing device to the mapping system for map data corresponding to the geographic area in response to a zoom level change within the viewport.

7. The method of claim 1, further comprising receiving map marker data corresponding to the location within the geographic area.

8. The method of claim 7, further comprising displaying a map marker corresponding to the map marker data at the location within the geographic area.

9. The method of claim 8, further comprising displaying the complete ordered collection of address elements in response to a hover or selection event in proximity to the map marker corresponding to the location within the geographic area.

10. A computer-readable medium storing tangible computer executable instructions to format addresses for locations within a map, the map displayed in a viewport of a mapping application executing on a client computing device, the medium comprising instructions to:
send a map data request from a client computing device to a mapping system for map data corresponding to a geographic area, the map data request including a search query term corresponding to a location within the geographic area;
receive both the map data corresponding to the geographic area and address data corresponding to the location within the geographic area in response to the map data request, the received map data including data corresponding to a plurality of graphic elements and the received address data including an ordered collection of address elements;
determine that more than one graphic element within the received map data represents an ordered address element of the received address data; and
display only the ordered address element and a next lowest address element of the received ordered collection of address elements with the received map data at the client computing device.

12. The computer-readable medium of claim 10, wherein:
the graphic element illustrates a country, a country subdivision within the country, a city within the country subdivision, a street within the city, or a building having a number within the street, and
the ordered collection of address elements includes, from highest to lowest, one or more of a country, a country subdivision within the country, a city within the country subdivision, a street within the city, and a house number within the street.

13. The computer-readable medium of claim 10, wherein:
the instructions to determine that more than one graphic element within the received map data represents the ordered address element of the received address data include instructions to determine that more than one graphic element within the received map data that is displayed within a viewport of the client computing device represents the ordered address element of the received address data,
the viewport includes a portion of a graphical user interface for a mapping module executing on the client computing device and the viewport displays a graphical representation of the received map data, and
the instructions to send the map data request from the client computing device to the mapping system for map data corresponding to the geographic area include instructions to send the map data request from the client computing device to the mapping system for map data corresponding to the geographic area in response to a zoom level change within the viewport.

14. The computer-readable medium of claim 10, further comprising instructions to:
receive map marker data corresponding to the location within the geographic area.
display a map marker corresponding to the map marker data at the location within the geographic area, and
display the complete ordered collection of address elements in response to a hover or selection event in proximity to the map marker corresponding to the location within the geographic area.

15. A computer system for formatting addresses for locations within a map, the map displayed in a viewport of a mapping application executing on the computer system, the system comprising:
a processor;
a memory communicatively coupled to the processor; and
a mapping module including instructions stored in the memory for execution by the processor to:
send a map data request from the computer system to a mapping system for map data corresponding to a geographic area, the map data request including a search query term corresponding to a location within the geographic area,
receive both the map data corresponding to the geographic area and address data corresponding to the location within the geographic area in response to the map data request, the received map data including data corresponding to a plurality of graphic elements and the received address data including an ordered collection of address elements,
determine that more than one graphic element within the received map data represents an ordered address element of the received address data, and
display only the ordered address element and a next lowest address element of the received ordered collection of address elements with the received map data.

16. The computer system of claim 15, wherein the graphic element illustrates a country, a country subdivision within the country, a city within the country subdivision, a street within the city, or a building having a number within the street.

17. The computer system of claim 16, wherein the ordered collection of address elements includes, from highest to lowest, one or more of a country, a country subdivision within the country, a city within the country subdivision, a street within the city, and a house number within the street.

18. The computer system of claim 15, wherein the instruction to determine that more than one graphic element within the received map data represents the ordered address element of the received address data includes an instruction to determine that more than one graphic element within the received map data that is displayed within a viewport of the computer system represents the ordered address element of the received address data.

19. The computer system of claim 18, wherein:
the viewport includes a portion of a graphical user interface for a mapping module executing on the computer system and the viewport displays a graphical representation of the received map data, and
the instructions to send the map data request from the computer system to the mapping system for map data corresponding to the geographic area include instructions to send the map data request from the computer system to the mapping system for map data corresponding to the geographic area in response to a zoom level change within the viewport.

20. The computer system of claim 15, wherein the mapping module includes further instructions stored in the memory for execution by the processor to:
receive map marker data corresponding to the location within the geographic area,
display a map marker corresponding to the map marker data at the location within the geographic area, and
display the complete ordered collection of address elements in response to a hover or selection event in proximity to the map marker corresponding to the location within the geographic area.
